(19) United States
(12) Patent Application Publication
(10) Pub. No.: US 2025/0202217 A1
(43) Pub. Date: Jun. 19, 2025

(54) METHOD FOR PROTECTING AGAINST FAULT ARCS

(71) Applicant: Siemens Aktiengesellschaft, München (DE)

(72) Inventors: Michael Anheuser, Kastl (DE); Wolfgang Erven, Amberg (DE); Karsten Wenzlaff, Dresden (DE); Yi Zhu, Kümmersbruck (DE)

(21) Appl. No.: 18/847,791

(22) PCT Filed: Mar. 2, 2023
(86) PCT No.: PCT/EP2023/055299

§ 371 Date: Sep. 17, 2024

(30) Foreign Application Priority Data
Mar. 17, 2022 (DE) 10 2022 202 654.3

(51) Int. Cl. H02H 1/00; H02H 3/08; H02H 7/26

(52) U.S. Cl. CPC H02H 1/0015; H02H 3/08; H02H 7/262

(57) ABSTRACT

A method for protecting against fault arcs in an electric power distribution system in which electric power from an electric power source is distributed via a common superordinate main distribution line and from the common main distribution line via multiple subordinate output lines. The main distribution line can be interrupted by a main switch, and each of the output lines can be interrupted by a paired output switch. When a fault arc is detected in the power distribution network based on electric voltage and/or current values in the main distribution line, a decision of whether to trigger a quenching process of the fault arc of the main switch or one of the output switches is made on the basis of voltage and/or current values in the output lines.

The present invention relates to a method for protecting against fault arcs, and to an electric power distribution system.

Arcs can occur operationally, whether in the form of a service arc or working arc (e.g. for supporting ignition in arc welding, in an arc furnace or in an arc lamp) or in the form of a switching arc, which is generated during a switching operation between the contacts of a mechanical switch. If arcing occurs in an unwanted or unexpected manner, rather than operationally, as a result of a malfunction, this is described as an accidental arc or fault arc. Particularly in high-capacity distribution and switchgear installations, fault arcs can result in the catastrophic destruction of operational equipment, system components or entire switchgear installations. In order to reduce damage and prevent a prolonged power supply outage, it is necessary for fault arcs, particularly high-current or parallel fault arcs, to be detected and quenched by means of a fault arc protection system within a few milliseconds (≤5 ms).

A fault arc protection system can generate a decisional conflict with respect to the priority of protective mechanisms in a switchgear installation. A fault arc protection system, by dint of its function for the rapid detection of a fault arc and the immediate quenching thereof by the disconnection of the switchgear installation from supply, assumes priority over all other protective mechanisms in the switchgear installation. A short-circuit algorithm of a power circuit-breaker, which detects the fault arc in the part of the system which is assigned thereto (tap-off or spur) as a short-circuit, is consequently overridden by the fault arc detection system. Any selectivity in the switchgear installation, namely, the selective switch-off of the spur in which a short-circuit is located, without intervening in adjoining spurs which are free of defects, is overridden accordingly.

Conventional fault arc protection systems on the market operate by the detection of fault arcs using light, by means of point or line sensors. In the interests of ensuring selectivity in the switchgear installation, only those regions of the switchgear installation which are to be protected against fault arcs are equipped with light sensors. Accordingly, the selection of those regions which are to be protected also has a critical influence upon circuit design, in terms of selectivity. A choice can only be made between fault arc protection or selectivity; a combination of both requirements is not possible. Moreover, an effective and lightproof screening (separation) of two different regions which are to be protected is required which, in general, cannot be practically implemented in switchgear installations.

For fault arc protection systems in which a detection of fault arcs is executed by means of current and voltage measurements, no solutions which permit selectivity are known. In this context, the above-mentioned issue is exacerbated on the grounds that, conversely to the case of light-based systems, the detection region of fault arcs can be locally delimited.

The object of the invention is thus the provision of an improved fault arc protection system.

According to the invention, this object is fulfilled by a method having the features disclosed in claim 1. According to the invention, this object is further fulfilled by an electric power distribution system having the features disclosed in claim 5. This object is moreover fulfilled by a computer program having the features disclosed in claim 9, and by a computer program product having the features disclosed in claim 10.

The method is employed for fault arc protection in an electric power distribution system in which electric power from an electric power source is distributed via a common superordinate main distribution line, and from the common main distribution line via multiple subordinate output lines. The main distribution line can be interrupted by means of a main switch, and each of the output lines can be interrupted by means of an associated output switch. Once a fault arc has been detected in the down-circuit power distribution system, on the basis of electric voltage and/or current values in the main distribution line, a decision is adopted as to whether the main switch or one of the output switches is to be tripped, in order to quench the fault arc. This decision is reached on the basis of voltage and/or current values in the output lines.

Fault arcs are preferably understood as high-current parallel fault arcs. The current of a high-current parallel fault arc of this type is an overcurrent, i.e. a current which exceeds the maximum operationally permissible current in the electric power distribution system. In a high-current parallel fault arc, the current is limited by no resistance or, potentially, by a relatively low resistance. A high-current parallel fault arc is thus distinguished from both a series fault arc, the current of which is limited by a load, and from a low-current parallel fault arc, the current of which is also limited by a resistance, e.g. by rodents which have infiltrated the power distribution system, or as a result of an oversight whereby conductive objects, such as tools or metal parts, are left in the power distribution system and establish an electrical connection between two phase conductors.

It is proposed, in an electric power distribution system, e.g. a switchgear installation, that a central fault arc detection function based upon electric voltage and/or current values in a superordinate level of the power distribution system be combined with a fault current detection function in a subordinate level of the power distribution system, by means of output switches, e.g. output-side power circuit-breakers. A fault current detection function can permit a detection of overcurrents, such as short-circuit currents. By means of its algorithms, the fault arc protection unit detects a fault arc in the electric power distribution system but, on the grounds of the functional principle employed, which is the measurement of electric voltage and/or current values, is not able to locate said fault arc in the power distribution system. This location function is assumed by the current measurement function of the output 11 switches. If a fault arc is present, current and voltage characteristics correspond to those of a short-circuit; a voltage dip, and thus an overcurrent, are established accordingly. This overcurrent is captured by the measurement and evaluation system of the output switches. As the arc fault algorithm responds very rapidly (0.5 ms-a maximum of 2 ms) and a fault current detection is executed by the output switches within the same time range, by means of communication between the output switches and the fault arc protection unit, it is possible to identify where the fault arc is located in the power distribution system. As a power distribution system is planned, and is thus known in detail, in the context of the dimensioning and design of operational equipment and components of the distribution system, it can be decided in which distribution level of the power distribution system a fault arc can be tolerated, in consideration of its damaging effects, and where it cannot. In the event of the occurrence of a fault arc in a subordinate level of the power distribution system, an associated output switch of this subordinate distribution level measures an overcurrent, and delivers a blockade signal to the fault arc protection unit. The fault arc protection unit is not active, i.e. the power distribution system is not switched to a completely de-energized state. Instead, the output switch is tripped, and the power distribution system is disconnected selectively, i.e. only at the output line which is affected by the fault arc. However, in the event of the occurrence of a fault arc in the superordinate distribution level of the power distribution system, between the infeed the output switches, the fault arc protection unit responds immediately, as no overcurrent signal from the subordinate distribution levels is present.

The fault arc protection unit and the individual output switches engage in mutual communication. In the event of a fault arc, the fault arc protection unit scans the output switches, and the output switches notify their status (fault or no fault). Coordination must be in force by the time of adoption of a trip decision by the fault arc protection unit, at the latest. Thereafter, a trip command is delivered by the fault arc protection unit to a main switch, e.g. a short-circuiting device, if no fault is notified by the output switches. However, in the event that a short-circuit is measured on one of the output switches, the trip command issued by the fault arc protection unit to a main switch is blocked or suppressed, or is not executed.

The electric power distribution system is hierarchically structured, i.e. it comprises a superordinate distribution level and one or more subordinate distribution levels. The power distribution system comprises a common superordinate main distribution line, which is connected to an electric power source. The power distribution system further comprises multiple subordinate output lines, which branch off from the common main distribution line. The power distribution system moreover comprises a main switch for interrupting the main distribution line, and a plurality of output switches for respectively interrupting one of the output lines. The power distribution system further comprises sensors for the capture of voltage and/or current values in the main distribution line and in the output lines. The power distribution system moreover comprises a fault arc protection unit for detecting a fault arc in the power distribution system on the basis of electric voltage and/or current values which have been measured in the main distribution line. The power distribution system further comprises a processor, which is configured to adopt a decision as to whether the fault arc is to be quenched by tripping the main switch or by tripping one of the output switches, on the basis of voltage and/or current values determined in the output lines.

The invention is based upon the finding whereby fault arc protection systems in which a detection of fault arcs in an electric power distribution system is executed by means of current and voltage measurements in a superordinate level of the power distribution system, preferably a main distribution line or feeder line, permit the achievement of a degree of selectivity, wherein a current detection function executed in subordinate levels of the power distribution system by an associated circuit-breaker, preferably by a corresponding power circuit-breaker or output switch, is employed. According to the severity of damage, a user will define those regions which are to be directly protected by the fault arc protection system. All other distribution levels, in which damage associated with the occurrence of a fault arc is of a tolerable magnitude, will continue to be protected by the associated circuit-breaker. The system provides an advantage, in that the fault arc protection system is restricted to the region of the main distribution line of a switchgear installation, or to those regions in which a fault arc would generate catastrophic damage. A further advantage is provided in that, by means of the invention, a degree of identification and tracking of the fault location, i.e. the location at which a fault arc is ignited, is possible.

Advantageous configurations and further developments of the invention are disclosed in the dependent claims. The method according to the invention can also be further developed in accordance with the dependent claims pertaining to the device, and vice versa.

According to a preferred configuration, the main switch is tripped in the event that no overcurrent has been detected in the output lines and, otherwise, only the output switch of the output line in which an overcurrent has been detected is tripped.

According to a preferred configuration, in the event that an overcurrent has been detected in one of the output lines, only the output switch in the output line in which the overcurrent has been detected is tripped, and the main switch is blocked.

According to a preferred configuration, in the event that an overcurrent has been detected in one of the output lines, the output switch in the output line in which the overcurrent has been detected is tripped by means of a trip signal.

According to a preferred configuration, for a subordinate level of the power distribution system, a dedicated evaluation unit for the status of output switches is installed. This evaluation unit evaluates signals from the output switches and communicates with the fault arc protection unit. An advantage is provided, in that the evaluation unit can execute pre-processing, which reduces the volume of data to be transmitted to the fault arc protection unit.

According to a preferred configuration, output switches are embodied in the form of fuses. By definition, fuse technology permits tripping only, but no measurement and/or evaluation. In order to permit signaling to the fault arc protection unit to the effect that a fuse is capable of clearing a short-circuit, a current measuring device is required in the output lines. To this end, additional current measuring devices are provided in the output lines which execute a current measurement function and transmit measured values to the fault arc protection unit, where measured values are centrally evaluated. Optionally, an evaluation of measured values is executed in evaluation devices which are additionally provided in the output lines. It is also possible for a fuse to be configured in the form of a smart fuse, which can execute a current measurement itself. It is possible for the current measuring device to be connected to a central evaluation unit. It is possible for the current measuring device, with effect from a specific current threshold value in the output line, to transmit a blockade signal to the central evaluation unit. It is only possible for a blockade signal to be transmitted by the fuse; execution in the reverse direction is not possible, namely, tripping of the interruption of the output line by the fuse in response to the reception of a trip signal by the fuse, on the grounds of the function of the fuse.

According to a preferred configuration, the central fault arc protection unit, in the event of the presence of an arcing fault in an output line—wherein a fault current has been detected by an output switch—transmits a trip signal to the subordinate output switch. The output switch is thus alerted to the arcing fault, thereby permitting an immediate tripping of the output switch. This configuration is particularly advantageous if the output switch features a time delay; in this case, tripping of the output switch, in the absence of the reception of a trip signal by the latter, would be excessively late in the above-mentioned fault situation, thus resulting in the unnecessary exacerbation of damage.

According to a preferred configuration, the fault arc protection unit is supplemented by an algorithm for early short-circuit detection. An option is thus provided, as a function of the impedance allocation of the power distribution system, for deciding whether the fault arc is present on the main level, i.e. up-circuit of the subordinate output switches, or on the subordinate output levels, i.e. down-circuit of the output switches. Various methods for early short-circuit detection are known, see e.g. Stege, Manfred: Short-circuit detection algorithms for current-limiting operation, Technical University of Braunschweig, dissertation, 1992, and WO 2009/056432A1 (applicant: Siemens AG; inventors: Berger, Frank; Mützel, Timo) May 7, 2009. The basis of these methods generally involves derivations of current and/or voltage. For example, from the magnitude of the short-circuit current, the line impedance between the site of measurement and the fault location can be concluded and, on the basis of known linear electric constants, an assignment can be determined as to whether the fault arc is ignited in a subordinate distribution level of the power distribution system or in the direct protection 11 region, i.e. in a superordinate distribution level of the 12 power distribution system. This decision-making criterion 13 permits a more rapid switch-out of a fault on the main level, as it is not necessary to await a response from a subordinate output switch.

According to a preferred configuration, the processor is integrated in the fault arc protection unit. One aspect of the invention is thus an arc fault protection unit having a processor which is appropriate for executing the steps of the method according to the invention. Alternatively, the processor can also be configured separately from the fault arc protection unit.

According to a preferred configuration, the processor is configured to transmit a trip signal to a first switch and/or a blockade signal to a second switch. The first switch is preferably an output switch which is arranged in a subordinate distribution level, and the second switch is preferably a main switch which is arranged in a superordinate distribution level.

According to a preferred configuration, the electric power distribution system comprises an evaluation unit which is configured to collect voltage and/or current values which are captured in the output lines, to execute the transmission thereof to the processor and, further to the reception of a command for the tripping of an output switch, which is transmitted by the processor, to transmit a trip signal to the corresponding output switch.

A further preferred configuration of the invention is a computer program product, comprising commands which initiate the execution by the fault arc protection unit of the process steps according to the invention.

A further preferred configuration of the invention is a computer program product which can be loaded directly in the internal memory of a digital computing unit and which comprises software code segments by means of which the above-mentioned method is executed.

The computer program product is configured to be executable in a processor. The computer program product can be saved in a memory in the form of software or firmware, and can be configured for execution by a computer unit. Alternatively or additionally, the computer program product can also be at least partially configured as a hard-wired circuit, for example in the form of an ASIC. The computer program product is configured to receive and evaluate measured values which are captured by sensors and to generate control commands for switches or protective devices of the power distribution system. According to the invention, the computer program product is configured to implement and execute at least one embodiment of the method outlined for quenching a fault arc. The computer program product can incorporate a combination of all the subfunctions of the method, i.e. can be monolithically configured. Alternatively, the computer program product can also be segmentally configured, with respective subfunctions distributed over segments which are executed on separate hardware. For example, one part of the method can be executed in a control unit, and another part of the method can be executed in a superordinate control unit such as, for example, a PLC or a computer cloud.

A computer program product is further proposed which can be loaded directly in the internal memory of a digital computing unit and which comprises software code segments by means of which the steps of the method described herein are executed, when the product is run on the computing unit. The computer program product can be stored on a data medium, such as e.g. a USB memory stick, a DVD or CD-ROM, a flash memory, EEPROM or a SD card. The computer program product can also be provided in the form of a signal which can be loaded via a hard-wired or wireless network.

For the purposes of automatic execution, the method is preferably embodied in the form of a computer program. The invention thus additionally comprises, on the one hand, a computer program having program code instructions which are executable by means of a computer and, on the other, a storage medium containing a computer program of this type, i.e. a computer program product with program code means and also, finally, a power source or a tertiary control unit, in the memory of which a computer program of this type is loaded or loadable, by way of means for executing the method and the configurations thereof.

In place of a computer program with individual program code instructions, implementation of the method described herein and hereinafter can also be executed in the form of firmware. It will be evident to a person skilled in the art that, in place of an implementation of a method in a software, implementation in firmware, or in firmware and software, or in firmware and hardware will also be possible throughout. In the description presented herein, it therefore applies that the term “software”, or the term “computer program”, also includes other implementation options, in particular an implementation in firmware, or in firmware and software, or in firmware and hardware.

The above-mentioned properties, features and advantages of the present invention, and the manner in which these are achieved, will be further explained and clarified by the following description, which is presented in greater detail with reference to the drawing. In each case, in a schematic and not true-to-scale representation:

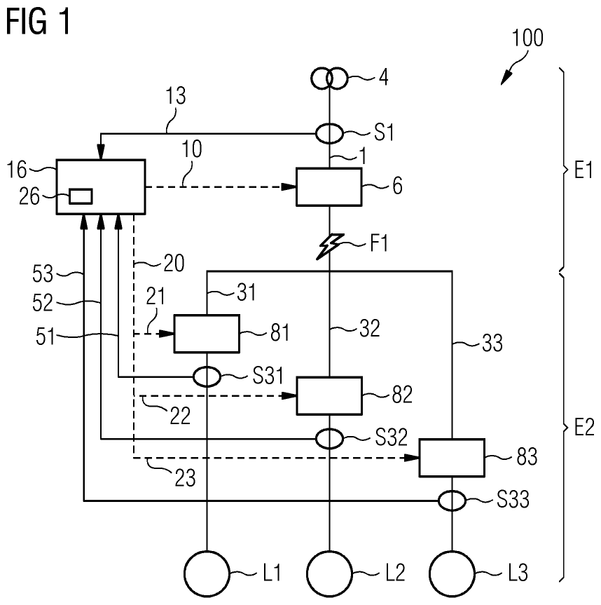

FIG. 1 shows an electric power distribution system according to a first embodiment;

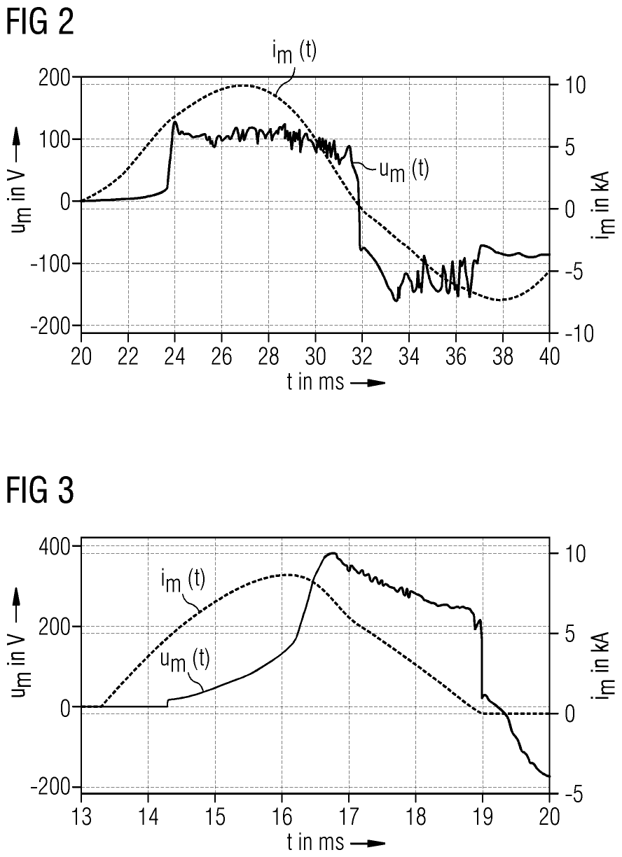

FIG. 2 shows a first diagram of the temporal voltage and current characteristic associated with fault arc ignition,

FIG. 3 shows a first diagram of the temporal voltage and current characteristic associated with switching arc ignition,

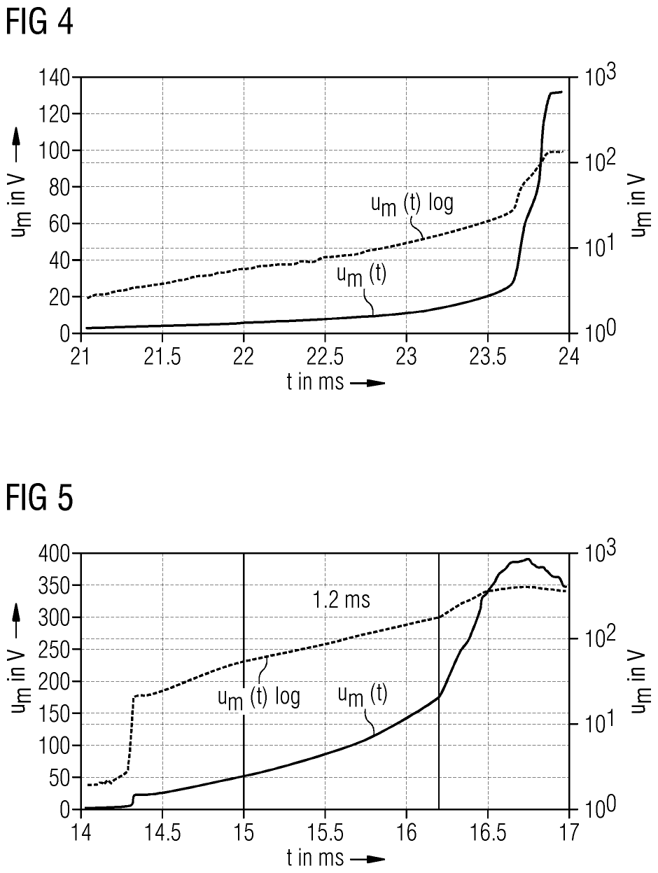

FIG. 4 shows a semi-logarithmic diagram of the temporal voltage characteristic associated with fault arc 14 ignition,

FIG. 5 shows a semi-logarithmic diagram of the temporal voltage characteristic associated with switching 17 arc ignition,

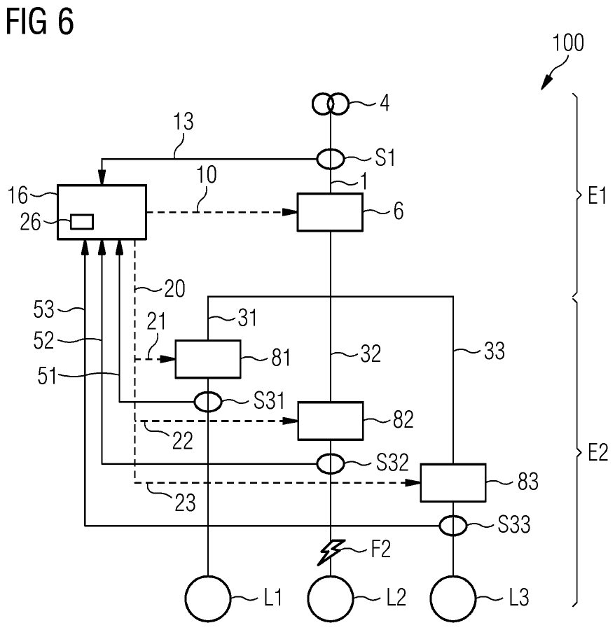

FIG. 6 shows an electric power distribution system according to an alternative embodiment;

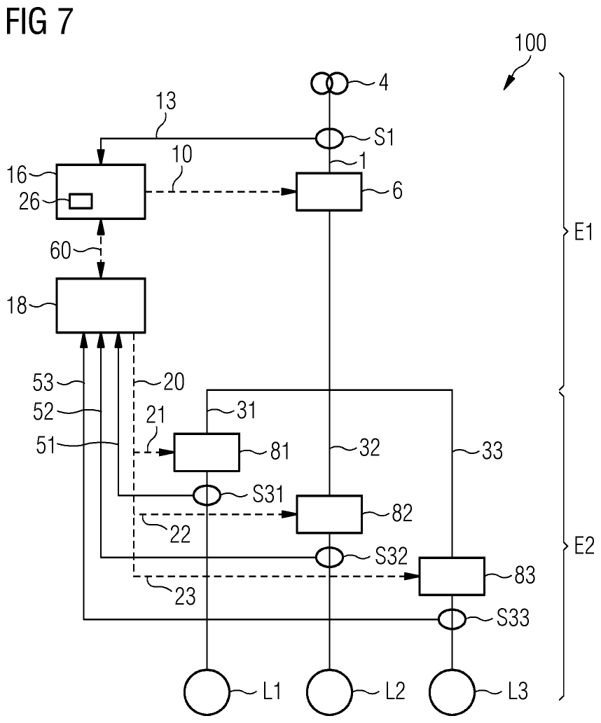

FIG. 7 shows an electric power distribution system according to a further embodiment;

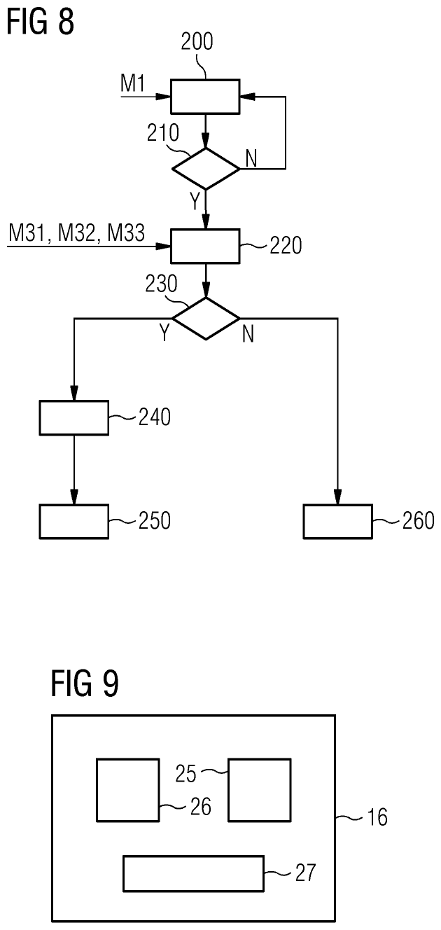

FIG. 8 shows a flow diagram of an algorithm for executing a method according to the invention; and

FIG. 9 shows a fault arc protection unit.

FIG. 1 shows an electric power distribution system 100, in which electric power is distributed from an electric power source 4 via a common superordinate main distribution line 1. The common main distribution line 1 branches into three subordinate output lines 31, 32, 33, which respectively distribute electric power supplied by the electric power source 4 to an electrical load L1, L2, L3. The main distribution line 1 thus forms a superordinate level E1 of the electric power distribution system 100, or the “main level”, and the output lines 31, 32, 33 form a subordinate level E2 of the electric power distribution system 100, the “sub-level” or “output level”.

The common main distribution line 1 and the separate output lines 31, 32, 33 can be configured for single-phase or multi-phase power distribution from the electric power source 4 to the electrical loads L1, L2, L3. For single-phase power distribution, it is sufficient that the common main distribution line 1 and the separate output lines 31, 32, 33 respectively comprise a single power conductor and, optionally, a return conductor or a neutral conductor. For three-phase power distribution, i.e. in a three-phase AC power grid for three-phase AC, it is sufficient that the common main distribution line 1 and the separate output lines 31, 32, 33 respectively comprise three separate power conductors-one conductor for each of the three current phases; additionally, a neutral conductor can be provided.

The main distribution line 1 can be interrupted by a main switch 6, which is configured in the form of a circuit-breaker, and the output lines 31, 32, 33 can be respectively interrupted by an associated output switch 81, 82, 83, which output switches are configured in the form of power circuit-breakers. In an alternative embodiment, the main switch 6 can be configured as a short-circuiting device, or as a combined power circuit-breaker and short-circuiting device which are connected in series in the main distribution line 1. In the main distribution line 1, a sensor S1 for determining voltage and/or current values in the main distribution line 1 is arranged. In a corresponding manner, a sensor S31, S32, S33 is also respectively arranged in the output lines 31, 32, 33, for determining voltage and/or current values in the output lines 31, 32, 33. The sensors S1, S31, S32, S33 are respectively connected to a sensor line 13, 51, 52, 53 for transmitting measured values which are captured by the sensors to a fault arc protection unit 16. From the fault arc protection unit 16, control lines 10, 20, 21, 22, 23 are respectively routed to the switches, i.e. to the main switch 6 and to the output switches 81, 82, 83, for the transmission of control signals, e.g. a trip signal or a blockade signal, from the fault arc protection unit 16 to the switches.

The sensors S1, S31, S32, S33 preferably measure current values in the output lines 31, 32, 33 on the grounds that, in the case of a parallel fault arc, current values are more expressive than voltage values of electric power distribution and fluxes in the power distribution system 100: in the event of a parallel fault arc—on whichever of the two levels, whether the main level E1 or the output level E2—the voltage dips substantially, and voltage differences at the measuring points of the sensors S31, S32, S33 are relatively small; current values at the measuring points of the sensors S31, S32, S33 are more meaningful, and are therefore preferentially employed.

The fault arc protection unit 16 is configured, on the basis of electric voltage and/or current values which have been measured by the sensor S1 in the main distribution line 1, to detect the ignition of a fault arc 2 in the power distribution system 100.

In the power circuit or grid in which an arc is ignited, a current and voltage characteristic can be measured, which represents a significant characteristic. FIG. 2 shows a representation of a potential temporal voltage characteristic uₘ (t) and a temporal current characteristic iₘ (t) for a fault arc. This figure shows a diagram in which the temporal characteristic of the electric voltage U and of the electric current I further to the ignition of an arc or fault arc, in particular a parallel fault arc, in an electric circuit, in particular a low-voltage circuit, is represented.

On the horizontal X axis, the time t in milliseconds (ms) [t in ms] is plotted. On the vertical Y axis, to the scale on the left-hand side, the magnitude of the electric voltage uₘ in volts (V) [uₘ in V] is plotted. The magnitude of the electric current iₘ in kiloamperes (kA) [iₘ in kA] is plotted, to the scale on the right-hand side.

Further to the ignition of the arc, the current I continues to assume a near-sinusoidal characteristic. The characteristic of the voltage U is severely distorted, in an approximate “sawtooth” pattern, with rapid voltage fluctuations. Roughly interpreted, the voltage characteristic, in a first approximation, assumes a square-wave form, rather than the customary sinusoidal characteristic. In abstract terms, a square-wave form is identifiable in the voltage characteristic, the plateau of which assumes a high stochastic component. The square-wave form is characterized in that, upon the ignition of an arc and in subsequent voltage zero-crossings, the alternating voltage undergoes significantly increased voltage fluctuations, which are thus described as a voltage jump, given that the rising ramp of the voltage variation is substantially steeper, in comparison with a sinusoidal voltage characteristic.

FIG. 3 shows a diagram of the temporal voltage and current characteristic according to FIG. 2, with the distinction that a switching arc ignition is represented.

If the characteristics according to FIGS. 2 and 3 are represented semi-logarithmically, the voltage characteristic response which is typical of a switching arc, and which differs from that of a fault arc, can be identified according to FIGS. 4 and 5.

FIG. 4 shows an illustration of the temporal voltage characteristic uₘ(t), uₘ(t) log associated with a fault arc ignition according to FIG. 2, plotted in a linear representation uₘ(t) on the one hand, and in a semi-logarithmic representation uₘ(t) log on the other. On the horizontal X axis, the time t in milliseconds (ms) [t in ms] is plotted. On the vertical Y axis, the magnitude of the electric voltage uₘ in volts (V) [uₘ in V] is plotted to the scale on the left-hand side, in a linear representation. In a logarithmic representation, the magnitude of the electric voltage uₘ in volts (V) [uₘ in V] is plotted to the scale on the right-hand side.

FIG. 5 shows a diagram according to FIG. 4, with the distinction that a switching arc ignition is represented. 12 FIGS. 2 to 5, which show arbitrarily selected examples of possible and potentially idealized arc voltage and current characteristics, are employed solely by way of illustration to the effect that it is thus possible, in a power circuit or an electric power grid, to detect the ignition of a fault arc by reference to current and/or voltage values. A method of this type for fault arc detection is described e.g. in DE 10 2016 209 445 A1 (applicant: Siemens AG; TU Dresden; inventors: Wenzlaff et al.) 2017.11.30.

In a first scenario, represented in FIG. 1, a fault arc F1 is ignited in the superordinate level E1 of the power distribution system 100, namely, in the main distribution line 1 between the main switch 1 and the junction at which the main distribution line 1 branches into the output lines 31, 32, 33. The sensor S1 of the main distribution line 1 captures measured values which are characteristic of a fault arc, and which are transmitted via the sensor line 13 to the fault arc protection unit 16. Conversely, no fault current is measured by the sensors S31, S32, S33 of the output lines 31, 32, 33. The fault arc protection unit 16 thus receives no signal from the sensors S31, S32, S33 of the output lines 31, 32, 33. From this combination of a) current and/or voltage values in the main distribution line 1 which are characteristic of a fault arc, and b) the absence of a fault current in the output lines 31, 32, 33, the fault arc protection unit 16 determines that the fault arc F1 is located in the main distribution line 1, i.e. in the superordinate level E1 of the power distribution system 100. To this end, the fault arc protection unit 16 comprises a processor 26, which is configured to execute a decision as to whether the fault arc is to be quenched by tripping the main switch or by tripping one of the output switches, on the basis of voltage and/or current values determined in the output lines. In consequence, the fault arc protection unit 16 transmits a trip signal to the main 12 switch 6, which can be configured e.g. in the form of a feeder circuit-breaker, with a short-circuiting device arranged down-circuit of the feeder circuit-breaker, in order to quench the fault arc F1.

In a second scenario, which is represented in FIG. 6, a fault arc F2 is ignited in the subordinate level E2 of the power distribution system 100, namely, in the central output line 32, between the junction at which the main distribution line 1 branches into the output lines 31, 32, 33 and the second load L2 which is supplied with electric power by the central output line 32. The sensor S1 of the main distribution line 1 captures measured values which are characteristic of a fault arc, and which are transmitted via the sensor line 13 to the fault arc protection unit 16. No fault current is measured by the sensors S31 and S33 of the left-side and right-side output lines 31 and 33, whereas the sensor S32 of the central output line 32 measures a fault current. The fault arc protection unit 16 thus receives no signal from the sensors S31 and S33 of the left-side and right-side output lines 31 and 33. However, measured values are transmitted from the sensor S32 of the central output line 32 to the fault arc protection unit 16 which indicate the presence of an overcurrent in the central output line 32. From this combination of a) current and/or voltage values in the main distribution line 1 which are characteristic of a fault arc, b) the absence of a fault current in the output lines 31 and 33, and c) a fault current in the central output line 32, the fault arc protection unit 16 determines that the fault arc F2 is located in the central output line 32, i.e. in the subordinate level E2 of the power distribution system 100. As a logical consequence, the fault arc protection unit 16 transmits a blockade signal to the main switch 6, which prevents any tripping of the main switch 6. As a result, the output switch 82 which is assigned to the central output line 32 is enabled to trip, in order to quench the fault arc F2.

FIG. 7 shows a configuration of the power distribution system 100 in which, by way of distinction from the embodiments represented in FIGS. 1 and 6, the output level E2 comprises a dedicated evaluation unit 18, which can communicate with the fault arc protection unit 16 via a bidirectional signal line 60. The evaluation unit 18 collects current and/or voltage values which are captured by the sensors S31, S32, S33 and transmitted via the sensor lines 51, 52, 53, evaluates these current and/or voltage values, transmits the results of evaluation via the signal line 60 to the fault arc protection unit 16, and receives control signals obtained from the fault arc protection unit 16 via the signal line 60, which are transmitted to the output switches 81, 82, 83 via the control lines 20, 21, 22, 23.

FIG. 8 shows a potential process sequence which can be embodied e.g. in the form of an algorithm. In a first step 200, an input is executed of current and/or voltage values M1 for the main distribution line 1 to the processor 26. In a subsequent step 210, a check is executed as to whether, on the basis of input current and/or voltage values for the main distribution line 1, a fault arc is detected in the power distribution system 100. A negative response (N) generates a return to step 200, and the process sequence commences again from the beginning. In the event of a positive response (Y), in step 220, an input is executed of current and/or voltage values M31, M32, M33 for the output lines 31, 32, 33 to the processor 26. In a subsequent step 230, a check is executed as to whether, on the basis of input current and/or voltage values for the output lines 31, 32, 33, a fault current, e.g. an overcurrent, is detected in one of the output lines 31, 32, 33. In the event of a positive response (Y), in step 240, transmission of a blockade signal to the main switch 6 and, in step 250, transmission of a trip signal to the output line 31, 32, 33 in which a fault current has been identified, are executed. In case of a negative response (N), in step 260, transmission of a trip signal to the main switch 6 is executed.

FIG. 9 shows a fault arc protection unit 16, which comprises a processor 26, a data memory 25 and a communication interface 27. Via the communication interface 27, the fault arc protection unit 16 can receive data, e.g. current and voltage measurement values from sensors or computer programs of superordinate entities, such as a control room or a control device, and can transmit e.g. control signals to switches. In the data memory 25, data can be saved, e.g. current and voltage measurement values from sensors or computer programs. The processor 26 can execute computing steps, e.g. the loading of a computer program which is saved in the data memory 25 into the working memory of the processor 26, and the processing thereof as a computing algorithm.

1-11. (canceled)

12. A method for fault arc protection in an electric power distribution system wherein electric power from an electric power source is distributed via a common superordinate main distribution line, and from the common main distribution line via multiple subordinate output lines, the method comprising:
providing the main distribution line with a main switch configured for interrupting the main distribution line and providing each of the subordinate output lines with respectively associated output switches configured for interrupting the subordinate output lines;
when a fault arc is detected in the power distribution system based on at least one of electric voltage values or electric current values in the main distribution line, rendering a decision as to whether the main switch or one of the output switches should be tripped, in order to quench the fault arc, on a basis of at least one of voltage values or current values in the subordinate output lines.

13. The method according to claim 12, which comprises tripping the main switch when no overcurrent has been detected in the output lines and, otherwise, tripping only the output switch in the output line in which an overcurrent has been detected.

14. The method according to claim 12, which comprises, when an overcurrent has been detected in one of the output lines, tripping only the output switch in the respective output line in which the overcurrent has been detected, and blocking the main switch.

15. The method according to claim 12, which comprises, when an overcurrent has been detected in one of the output lines, tripping the output switch in the respective output line in which the overcurrent has been detected by issuing of a trip signal.

16. An electric power distribution system, comprising:
a common superordinate main distribution line connected to an electric power source;
a main switch configured for interrupting the main distribution line;
multiple subordinate output lines branching off from said common main distribution line;
output switches for respectively interrupting one of the output lines;
sensors configured for capturing at least one of voltage values or current values in said main distribution line and in said output lines;
a fault arc protection unit for detecting a fault arc in the power distribution system on a basis of at least one of electric voltage values or current values measured in said main distribution line; and
a processor configured to render a decision whether the fault arc is to be quenched by tripping the main switch or by tripping one of the output switches, the decision being based on at least one of the voltage values or the current values determined in said output lines.

17. The electric power distribution system according to claim 16, wherein the processor is integrated in said fault arc protection unit.

18. The electric power distribution system according to claim 16, wherein said processor is configured to transmit at least one of a trip signal to a first switch or a blockade signal to a second switch.

19. The electric power distribution system according to claim 16, further comprising an evaluation unit configured to evaluate voltage and/or current values detected in said output lines, to execute a transmission thereof to said processor and, in response to receiving a command for tripping an output switch from said processor, to transmit a trip signal to a respective said output switch.

20. A fault arc protection unit comprising a processor configured for executing the steps of the method according to claim 12.

21. A non-transitory computer program product, comprising computer-executable commands, to be executed by a fault arc protection unit configured to perform the method according to claim 12.

22. A non-transitory computer-readable medium having stored thereon the computer program according to claim 21.
